(19) United States
(12) Patent Application Publication
(10) Pub. No.: US 2020/0270824 A1
(43) Pub. Date: Aug. 27, 2020

(54) ROAD SURFACE PROFILE ESTIMATION DEVICE, ROAD SURFACE PROFILE ESTIMATI0N SYSTEM, ROAD SURFACE PROFILE ESTIMATION METHOD, AND ROAD SURFACE PROFILE ESTIMATION PROGRAM

(71) Applicant: The University of Tokyo, Tokyo (JP)

(72) Inventors: Tomonori NAGAYAMA, Tokyo (JP); Boyu ZHAO, Tokyo (JP); Haoqi WANG, Tokyo (JP)

(21) Appl. No.: 16/608,669

(22) PCT Filed: Apr. 27, 2018
(86) PCT No.: PCT/JP2018/017182

§ 371 Date: Jan. 10, 2020

(30) Foreign Application Priority Data
Apr. 27, 2017 (JP) 2017-088700

(51) Int. Cl. E01C 23/01; G01B 21/30; G01C 7/04

(52) U.S. Cl. CPC E01C 23/01; B60W 40/06; G01C 7/04; G01B 21/30

(57) ABSTRACT

The present invention provides a road surface profile estimation device and so on with which any road surface profile, including that of a general road, can be estimated with a high degree of precision using a general-purpose vehicle. The road surface profile estimation device includes an acquisition unit that acquires a vertical acceleration and angular velocity about a pitch axis, a first calculation unit that calculates a vertical displacement and an angular displacement about the pitch axis, a prediction unit that predicts the time evolution of state variables of the vehicle on the basis of a simulation model, a second calculation unit that calculates the acceleration, the angular velocity, the displacement, and the angular displacement from the state variables on the basis of an observation model, an updating unit that updates the state variables by data-assimilating the acceleration and angular velocity acquired by the acquisition unit and the displacement and angular displacement calculated by the first calculation unit with the acceleration, angular velocity, displacement, and angular displacement calculated by the second calculation unit, and an estimation unit that estimates the road surface profile on the basis of the state variables.

### TECHNICAL FIELD

The present invention relates to a road surface profile estimation device, a road surface profile estimation system, a road surface profile estimation method, and a road surface profile estimation program.

### BACKGROUND ART

Conventionally, in order to evaluate the longitudinal shape (referred to hereafter as the road surface profile) of a road surface, unevenness on the road surface may be measured, and an index such as an IRI (International Roughness Index), for example, may be calculated. Information relating to the road surface profile may be used to determine whether the road surface requires maintenance and evaluate the comfort level when traveling by vehicle.

Patent Publication JP-A-2017-040486 describes a measurement device that determines a travel distance and a vertical direction displacement of a bicycle on the basis of data measured by a speed sensor, an acceleration sensor, and an angular velocity sensor mounted on the bicycle, and determines the road surface profile of a bicycle path by either associating the travel distance and an acceleration-based vertical direction displacement with each other or combining the acceleration-based vertical direction displacement with an angular velocity-based vertical direction displacement and associating the resulting combination with the travel distance.

### SUMMARY

### Technical Problem

A road surface profile may be estimated using a dedicated vehicle equipped with a high-precision laser distance meter. However, a dedicated vehicle for estimating a road surface profile is expensive, and operators capable of using the vehicle are limited. Moreover, a dedicated vehicle for estimating a road surface profile may be designed for the purpose of estimating the road surface profile of an expressway and may not always be suitable for estimating the road surface profile of a general road.

Meanwhile, a road surface profile may be estimated by mounting a simple sensor on a general-purpose vehicle, but in this case, it may not be possible to acquire sufficient precision.

Hence, the present invention provides a road surface profile estimation device, a road surface profile estimation system, a road surface profile estimation method, and a road surface profile estimation program with which any road surface profile, including that of a general road, can be estimated with a high degree of precision using a general-purpose vehicle.

### Solution to Problem

A road surface profile estimation device according to one aspect of the present invention includes an acquisition unit that acquires a vertical acceleration relative to a road surface with which a vehicle is in contact and angular velocity about a pitch axis of the vehicle, a first calculation unit that calculates a vertical displacement by integrating the acceleration and calculates an angular displacement about the pitch axis by integrating the angular velocity, a prediction unit that predicts, on the basis of a simulation model, a time evolution of state variables including variables expressing unevenness on a road surface along which the vehicle is traveling, variables expressing up-down motion of the vehicle, and variables expressing rotary motion about the pitch axis of the vehicle, a second calculation unit that calculates, on the basis of an observation model, the acceleration, the angular velocity, the displacement, and the angular displacement from the state variables predicted by the prediction unit, an updating unit that updates the state variables by data-assimilating the acceleration and the angular velocity acquired by the acquisition unit and the displacement and the angular displacement calculated by the first calculation unit with the acceleration, the angular velocity, the displacement, and the angular displacement calculated by the second calculation unit, and an estimation unit that estimates the road surface profile on the basis of the variables expressing the unevenness of the road surface, included in the state variables.

According to this aspect, by employing in data assimilation not only the vertical acceleration relative to the road surface with which the vehicle is in contact and the angular velocity about the pitch axis of the vehicle but also the vertical displacement and the angular displacement about the pitch axis, highly stable analysis can be realized, and as a result, the profile of any road surface, including that of a general road, can be estimated with a high degree of precision using a general-purpose vehicle.

The aspect described above may further include a smoothing unit that smoothes the state variables on the basis of the acceleration and the angular velocity acquired by the acquisition unit and the displacement and the angular displacement calculated by the first calculation unit following a point at which the prediction unit executes prediction.

According to this aspect, by employing in data smoothing not only the vertical acceleration of the vehicle and the angular velocity about the pitch axis of the vehicle but also the vertical displacement and the angular displacement about the pitch axis, the road surface profile can be estimated with an even higher degree of precision.

In the aspect described above, the simulation model may be a half car model of the vehicle, and the state variables may be variables expressing states of the half car model.

According to this aspect, the operating state of the vehicle can be expressed more accurately than when a quarter car model is used as the simulation model, and as a result, the time evolution of the state variables can be predicted with a higher degree of precision.

In the aspect described above, the variables expressing the unevenness of the road surface may include a vertical displacement and a vertical speed of a front tire of the half car model, and a vertical displacement and a vertical speed of a rear tire of the half car model, the variables expressing the up-down motion of the vehicle may include a vertical displacement and a vertical speed of a center of gravity of the half car model, a vertical displacement and a vertical speed of a front suspension of the half car model, and a vertical displacement and a vertical speed of a rear suspension of the half car model, and the variables expressing the rotary motion about the pitch axis of the vehicle may include an angle of rotation and an angular velocity about a pitch axis passing through the center of gravity of the half car model.

In the aspect described above, the simulation model may be a model expressing the time evolution of the state variables by a linear transformation or a non-linear transformation of the state variables and Gaussian noise or non-Gaussian noise, and the observation model may be a model for calculating the acceleration, the angular velocity, the displacement, and the angular displacement using a linear transformation or a non-linear transformation of the state variables and Gaussian noise or non-Gaussian noise.

According to this aspect, by expressing the time evolution of the state variables using a simulation model that includes a non-linear transformation and non-Gaussian noise and expressing observation using an observation model that includes a non-linear transformation and non-Gaussian noise, non-linear behavior and non-Gaussian vibration can be described accurately, and as a result, the road surface profile can be estimated with an even higher degree of precision.

In the aspect described above, the simulation model may be a model expressing the time evolution of the state variables by a linear transformation of the state variables and Gaussian noise, the observation model may be a model for calculating the acceleration, the angular velocity, the displacement, and the angular displacement using a linear transformation of the state variables and Gaussian noise, and the updating unit may update the state variables so as to minimize a square error of the state variables.

According to this aspect, by expressing the time evolution of the state variables using a simulation model that includes a linear transformation and Gaussian noise and expressing observation using an observation model that includes a linear transformation and Gaussian noise, the road surface profile can be estimated by comparatively low-load calculation.

A road surface profile estimation system according to another aspect of the present invention includes an accelerometer disposed in a vehicle in order to measure a vertical acceleration relative to a road surface with which the vehicle is in contact, an angular velocity meter disposed in the vehicle in order to measure an angular velocity about a pitch axis of the vehicle, and a road surface profile estimation device for estimating a profile of a road surface along which the vehicle is traveling, the road surface profile estimation device including an acquisition unit that acquires the acceleration from the accelerometer and the angular velocity from the angular velocity meter, a first calculation unit that calculates a vertical displacement by integrating the acceleration and calculates an angular displacement about the pitch axis by integrating the angular velocity, a prediction unit that predicts, on the basis of a simulation model, a time evolution of state variables including variables expressing unevenness on the road surface along which the vehicle is traveling, variables expressing up-down motion of the vehicle, and variables expressing rotary motion about the pitch axis of the vehicle, a second calculation unit that calculates, on the basis of an observation model, the acceleration, the angular velocity, the displacement, and the angular displacement from the state variables predicted by the prediction unit, an updating unit that updates the state variables by data-assimilating the acceleration and the angular velocity acquired by the acquisition unit and the displacement and the angular displacement calculated by the first calculation unit with the acceleration, the angular velocity, the displacement, and the angular displacement calculated by the second calculation unit, and an estimation unit that estimates the road surface profile on the basis of the variables expressing the unevenness of the road surface, included in the state variables.

According to this aspect, by employing in data assimilation not only the vertical acceleration relative to the road surface with which the vehicle is in contact and the angular velocity about the pitch axis of the vehicle but also the vertical displacement and the angular displacement about the pitch axis, highly stable analysis can be realized, and as a result, the profile of any road surface, including that of a general road, can be estimated with a high degree of precision using a general-purpose vehicle.

A device method of estimating a road surface profile according to a further aspect of the present invention includes a first step of acquiring a vertical acceleration relative to a road surface with which a vehicle is in contact and angular velocity about a pitch axis of the vehicle, a second step of calculating a vertical displacement by integrating the acceleration and calculating an angular displacement about the pitch axis by integrating the angular velocity, a third step of predicting, on the basis of a simulation model, a time evolution of state variables including variables expressing unevenness on a road surface along which the vehicle is traveling, variables expressing up-down motion of the vehicle, and variables expressing rotary motion about the pitch axis of the vehicle, a fourth step of calculating, on the basis of an observation model, the acceleration, the angular velocity, the displacement, and the angular displacement from the state variables predicted in the third step, a fifth step of updating the state variables by data-assimilating the acceleration and the angular velocity acquired in the first step and the displacement and the angular displacement calculated in the second step with the acceleration, the angular velocity, the displacement, and the angular displacement calculated in the fourth step, and a sixth step of estimating the road surface profile on the basis of the variables expressing the unevenness of the road surface, included in the state variables.

According to this aspect, by employing in data assimilation not only the vertical acceleration relative to the road surface with which the vehicle is in contact and the angular velocity about the pitch axis of the vehicle but also the vertical displacement and the angular displacement about the pitch axis, highly stable analysis can be realized, and as a result, the profile of any road surface, including that of a general road, can be estimated with a high degree of precision using a general-purpose vehicle.

A road surface profile estimation program according to a further aspect of the present invention causes a computer provided in a road surface profile estimation device to function as an acquisition unit that acquires a vertical acceleration relative to a road surface with which a vehicle is in contact and angular velocity about a pitch axis of the vehicle, a first calculation unit that calculates a vertical displacement by integrating the acceleration and calculates an angular displacement about the pitch axis by integrating the angular velocity, a prediction unit that predicts, on the basis of a simulation model, a time evolution of state variables including variables expressing unevenness on a road surface along which the vehicle is traveling, variables expressing up-down motion of the vehicle, and variables expressing rotary motion about the pitch axis of the vehicle, a second calculation unit that calculates, on the basis of an observation model, the acceleration, the angular velocity, the displacement, and the angular displacement from the state variables predicted by the prediction unit, an updating unit that updates the state variables by data-assimilating the acceleration and the angular velocity acquired by the acquisition unit and the displacement and the angular displacement calculated by the first calculation unit with the acceleration, the angular velocity, the displacement, and the angular displacement calculated by the second calculation unit, and an estimation unit that estimates the road surface profile on the basis of the variables expressing the unevenness of the road surface, included in the state variables.

According to this aspect, by employing in data assimilation not only the vertical acceleration relative to the road surface with which the vehicle is in contact and the angular velocity about the pitch axis of the vehicle but also the vertical displacement and the angular displacement about the pitch axis, highly stable analysis can be realized, and as a result, the profile of any road surface, including that of a general road, can be estimated with a high degree of precision using a general-purpose vehicle.

### Advantageous Effects of Invention

According to the present invention, it is possible to provide a road surface profile estimation device, a road surface profile estimation system, a road surface profile estimation method, and a road surface profile estimation program with which any road surface profile, including that of a general road, can be estimated with a high degree of precision using a general-purpose vehicle.

### BRIEF DESCRIPTION OF DRAWINGS

FIG. 1 is a schematic view of a road surface profile estimation system according to a first embodiment of the present invention.

FIG. 2 is a function block diagram of a road surface profile estimation device according to the first embodiment of the present invention.

FIG. 3 is a conceptual diagram of a simulation model used by the road surface profile estimation device according to the first embodiment of the present invention.

FIG. 4 is a flowchart of first processing executed by the road surface profile estimation device according to the first embodiment of the present invention.

FIG. 5 is a flowchart of second processing executed by the road surface profile estimation device according to the first embodiment of the present invention.

FIG. 6 is a first graph showing a relationship between a travel distance and a road surface profile, estimated by the road surface profile estimation system according to the first embodiment of the present invention.

FIG. 7 is a second graph showing the relationship between the travel distance and the road surface profile, estimated by the road surface profile estimation system according to the first embodiment of the present invention.

FIG. 8 is a third graph showing the relationship between the travel distance and the road surface profile, estimated by the road surface profile estimation system according to the first embodiment of the present invention.

FIG. 9 is a fourth graph showing a power spectrum of the road surface profile estimated by the road surface profile estimation system according to the first embodiment of the present invention.

FIG. 10 is a fifth graph showing the travel distance and the speed of a vehicle during estimation of the road surface profile by the road surface profile estimation system according to the first embodiment of the present invention.

FIG. 11 is a sixth graph showing the travel distance and the speed of the vehicle during estimation of the road surface profile by the road surface profile estimation system according to the first embodiment of the present invention.

FIG. 12 is a flowchart of third processing executed by a road surface profile estimation device according to a second embodiment of the present invention.

### DESCRIPTION OF EMBODIMENTS

Embodiments of the present invention will be described below with reference to the attached figures. Note that in the figures, components with identical reference numerals have identical or similar configurations.

### First Embodiment

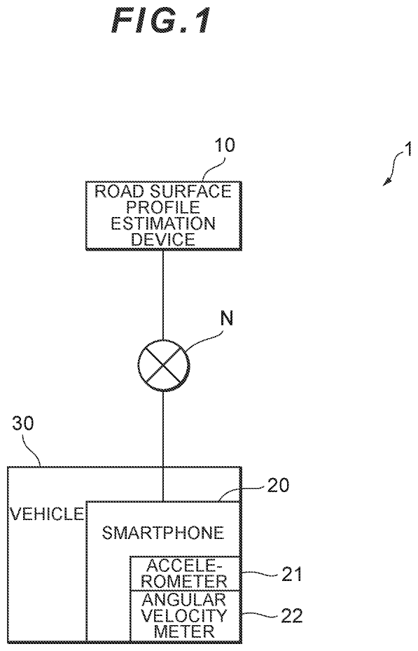

FIG. 1 is a schematic view of a road surface profile estimation system 1 according to a first embodiment of the present invention. The road surface profile estimation system 1 includes a vehicle 30, an accelerometer 21 that measures vertical acceleration relative to a road surface with which the vehicle 30 is in contact, an angular velocity meter 22 that measures angular velocity about a pitch axis of the vehicle 30, and a road surface profile estimation device 10 that estimates the profile of the road surface along which the vehicle 30 is traveling. In the road surface profile estimation system 1 according to this embodiment, the accelerometer 21 and the angular velocity meter 22 are built into a smartphone 20. The smartphone 20 may be disposed in any desired location, such as on the dashboard or in the trunk of the vehicle 30. Needless to mention, the accelerometer 21 and the angular velocity meter 22 may also be disposed in the vehicle 30 independently. The accelerometer 21 measures vertical acceleration relative to the road surface with which the vehicle 30 is in contact, but does not necessarily have to measure only vertical acceleration and may also measure horizontal acceleration relative to the road surface. Of the plurality of components of the acceleration of the vehicle 30, the accelerometer 21 is to measure at least the vertical component relative to the road surface. The angular velocity meter 22 measures angular velocity about the pitch axis of the vehicle 30 but does not necessarily have to measure only the angular velocity about the pitch axis and may also measure angular velocity about a roll axis and angular velocity about a yaw axis of the vehicle 30. Of the angular velocities relative to the plurality of axes of the vehicle 30, the angular velocity meter 22 is to measure at least the angular velocity about the pitch axis.

The road surface profile estimation device 10 estimates the profile of the road surface along which the vehicle 30 is traveling on the basis of the acceleration and angular velocity measured by the accelerometer 21 and the angular velocity meter 22, and so on. In the road surface profile estimation system 1 according to this embodiment, the road surface profile estimation device 10 is connected to the smartphone 20 over a communication network N. Here, the communication network N may be a wired or wireless communication network. Note that the road surface profile estimation device 10 does not necessarily have to be independent of the smartphone 20 and may be formed integrally with the smartphone 20. In this case, the smartphone 20 may be caused to function as the road surface profile estimation device 10 by executing a road surface profile estimation program installed in the smartphone 20.

The vehicle 30 may be an automobile that travels along a road surface on the tires of four wheels. Needless to mention, the vehicle 30 may also be a three-wheel or two-wheel vehicle and may also have five or more wheels. An automobile of any size may be used as the vehicle 30, and in this specification, cases in which a light vehicle (Light), a small vehicle (Small), and a middle-sized vehicle (Middle) are used as the vehicle 30 will be described.

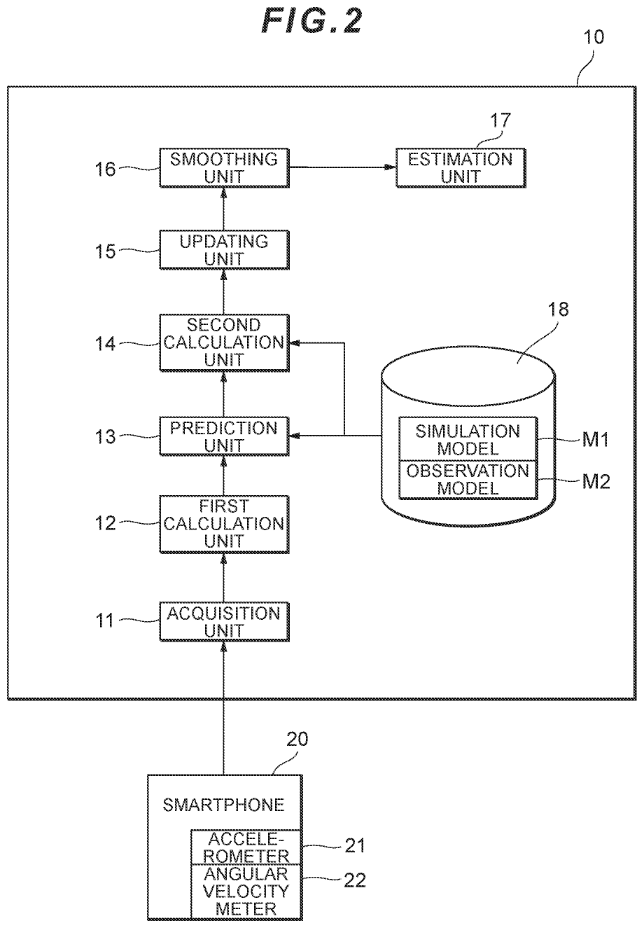

FIG. 2 is a function block diagram of the road surface profile estimation device 10 according to the first embodiment of the present invention. The road surface profile estimation device 10 includes an acquisition unit 11, a first calculation unit 12, a prediction unit 13, a second calculation unit 14, an updating unit 15, a smoothing unit 16, an estimation unit 17, and a storage unit 18.

The acquisition unit 11 acquires the vertical acceleration relative to the road surface with which the vehicle 30 is in contact and the angular velocity about the pitch axis of the vehicle 30. The acquisition unit 11 may acquire the acceleration and the angular velocity from the accelerometer 21 and the angular velocity meter 22 built into the smartphone 20 by communicating with the smartphone 20.

The first calculation unit 12 calculates a vertical displacement by integrating the acceleration and calculates an angular displacement about the pitch axis by integrating the angular velocity. The first calculation unit 12 calculates the vertical displacement by executing second order integration relative to time on the acceleration acquired by the acquisition unit 11. Further, the first calculation unit 12 calculates the angular displacement about the pitch axis by executing first order integration relative to time on the angular velocity acquired by the acquisition unit 11.

The prediction unit 13 predicts the time evolution of state variables including variables expressing unevenness on the road surface along which the vehicle 30 is traveling, variable expressing up-down motion of the vehicle 30, and variables expressing rotary motion of the vehicle 30 about the pitch axis on the basis of a simulation model M1. Here, the simulation model M1 is stored in the storage unit 18. In this embodiment, the simulation model M1 is a half car model of the vehicle 30, and the state variables are variables expressing states of the half car model. More specifically, the variables expressing unevenness on the road surface include the vertical displacement and speed of a front tire of the half car model, and the vertical displacement and speed of a rear tire of the half car model. Further, the variables expressing the up-down motion of the vehicle 30 include the vertical displacement and speed of the center of gravity of the half car model, the vertical displacement and speed of a front suspension of the half car model, and the vertical displacement and speed of a rear suspension of the half car model. Furthermore, the variables expressing the rotary motion of the vehicle 30 about the pitch axis include an angle of rotation and an angular velocity about a pitch axis passing through the center of gravity of the half car model.

The second calculation unit 14 calculates the vertical acceleration relative to the road surface with which the vehicle 30 is in contact, the angular velocity about the pitch axis, the vertical displacement, and the angular displacement about the pitch axis from the state variables predicted by the prediction unit 13 on the basis of an observation model M2. The observation model M2 is stored in the storage unit 18.

The updating unit 15 updates the state variables by data-assimilating the acceleration and angular velocity acquired by the acquisition unit 11 and the displacement and angular displacement calculated by the first calculation unit 12 with the acceleration, angular velocity, displacement, and angular displacement calculated by the second calculation unit 14. Here, data assimilation denotes processing for improving the prediction precision by updating the state variables predicted using the simulation model M1 on the basis of actual measured values. A specific example of data assimilation will be described in detail below.

The smoothing unit 16 smoothes the state variables on the basis of the acceleration and angular velocity acquired by the acquisition unit 11 and the displacement and angular displacement calculated by the first calculation unit 12 following prediction by the prediction unit 13.

The estimation unit 17 estimates the road surface profile on the basis of the variables expressing unevenness on the road surface, included in the state variables. Here, the road surface profile denotes the longitudinal shape of the road surface.

The storage unit 18 stores the simulation model M1 and the observation model M2. In the road surface profile estimation device 10 according to this embodiment, the simulation model M1 is a model expressing the time evolution of the state variables by a linear transformation of the state variables and Gaussian noise, while the observation model M2 is a model for calculating the vertical acceleration relative to the road surface with which the vehicle 30 is in contact, the angular velocity about the pitch axis of the vehicle 30, the vertical displacement, and the angular displacement about the pitch axis from a linear transformation of the state variables and Gaussian noise. Further, the updating unit 15 updates the state variables so as to minimize a square error of the state variables. As will be described in detail below, the prediction unit 13, second calculation unit 14, and updating unit 15 of the road surface profile estimation device 10 according to this embodiment together function as a Kalman filter.

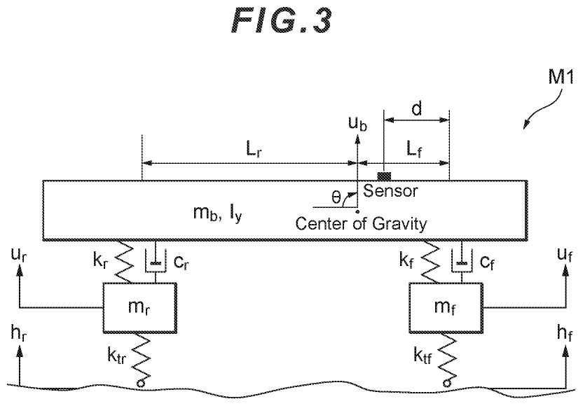

FIG. 3 is a conceptual diagram of the simulation model M1 used by the road surface profile estimation device 10 according to the first embodiment of the present invention. The simulation model M1 is a half car model including 12 state variables and 13 parameters.

The state variables include a vertical displacement h_{f} and a vertical speed dh_{f}/dt of the front tire of the half car model, a vertical displacement hᵣ and a vertical speed dhᵣ/dt of the rear tire of the half car model, a vertical displacement u_{b} and a vertical speed du_{b}/dt of the center of gravity of the half car model, a vertical displacement u_{f} and a vertical speed du_{f}/dt of the front suspension of the half car model, a vertical displacement uᵣ and a vertical speed duᵣ/dt of the rear suspension of the half car model, and an angle of rotation θ and an angular velocity dθ/dt about a pitch axis passing through the center of gravity of the half car model.

The parameters include a spring constant k_{tf} of the front tire of the half car model, a mass m_{f} of the front tire, a spring constant k_{f} and a damping coefficient c_{f} of the front suspension, a spring constant ktᵣ of the rear tire of the half car model, a mass mᵣ of the rear tire, a spring constant kᵣ and a damping coefficient cᵣ of the rear suspension, a mass m_{b} and a moment of inertia l_{y} about the pitch axis of the vehicle body of the half car model, a horizontal distance L_{f} from the center of gravity of the half car model to a ground contact point of the front tire, a horizontal distance Lᵣ from the center of gravity of the half car model to a ground contact point of the rear tire, and a horizontal distance d from the ground contact point of the front tire to a disposal point of the accelerometer 21 and the angular velocity meter 22.

By employing a half car model as the simulation model M1, the operating state of the vehicle 30 can be expressed more accurately than when a quarter car model is used, and as a result, the time evolution of the state variables can be predicted with a higher degree of precision.

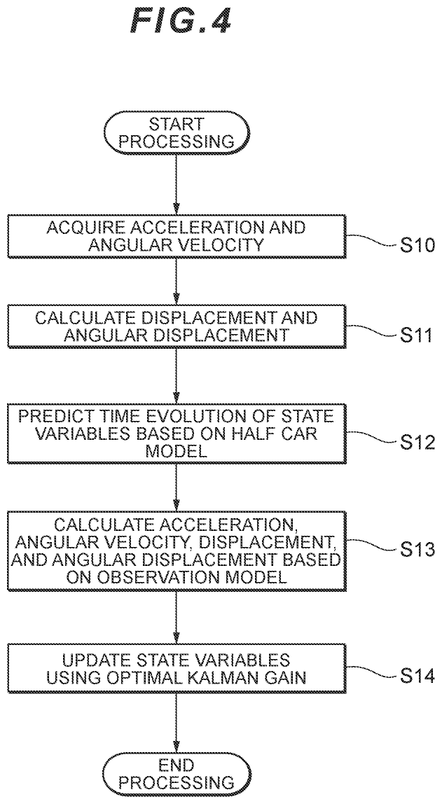

FIG. 4 is a flowchart of first processing executed by the road surface profile estimation device 10 according to the first embodiment of the present invention. The first processing is processing executed by the road surface profile estimation device 10 to data-assimilate the state variables with measured values using a Kalman filter.

The road surface profile estimation device 10 uses the acquisition unit 11 to acquire the vertical acceleration relative to the road surface with which the vehicle 30 is in contact and the angular velocity about the pitch axis of the vehicle 30 (S10). Measurement of the acceleration by the accelerometer 21 and measurement of the angular velocity by the angular velocity meter 22 may be performed at predetermined time intervals. The acquisition unit 11 may acquire the acceleration and the angular velocity every time measurement is performed by the accelerometer 21 and the angular velocity meter 22 or acquire the acceleration and the angular velocity together once measurement is complete.

The first calculation unit 12 calculates a vertical displacement by integrating the acceleration acquired by the acquisition unit 11, and calculates an angular displacement about the pitch axis by integrating the angular velocity (S11). The acceleration and angular velocity acquired by the acquisition unit 11 and the displacement and angular displacement calculated by the first calculation unit 12 are expressed together by a vector y.

The prediction unit 13 predicts the time evolution of the state variables on the basis of the half car model (S12). The time evolution of the state variables is determined on the basis of an equation of motion expressed by formula (1) below.

MÜ(t)+C\dot{U}(t)+KU(t)=P(t) [Math. 1]

Here, a vector U is expressed by formula (2) below. The vector U includes, as vector components, the vertical displacement u_{b} of the center of gravity of the half car model, the angular displacement θ about the pitch axis passing through the center of gravity, the vertical displacement u_{f} of the front suspension of the half car model, and the vertical displacement uᵣ of the rear suspension of the half car model.

U=[u_{b}θu_{f}uᵣ]^{T} [Math. 2]

Further, matrices M, C, and K, which are given respectively by following formulae (3) to (5), are parameter-dependent quantities.

$$\begin{matrix}M = [ \begin{matrix}m & 0 & 0 & 0 \\ 0 & {I}_{y} & 0 & 0 \\ 0 & 0 & {m}_{f} & 0 \\ 0 & 0 & 0 & {m}_{r}\end{matrix} ] & [ Math . 3 ] \\ C = [ \begin{matrix}{c}_{f} + {c}_{r} & {L}_{r} {c}_{r} - {L}_{f} {c}_{f} & - {c}_{f} & - {c}_{r} \\ {L}_{r} {c}_{r} - {L}_{f} {c}_{f} & {L}_{f}^{2} {c}_{f} + {L}_{r}^{2} {c}_{r} & {L}_{f} {c}_{f} & - {L}_{r} {c}_{r} \\ - {c}_{f} & {L}_{f} {c}_{f} & {c}_{f} & 0 \\ - {c}_{r} & - {L}_{r} {c}_{r} & 0 & {c}_{r}\end{matrix} ] & [ Math . 4 ] \\ K = [ \begin{matrix}{k}_{f} + {k}_{r} & {L}_{r} {k}_{r} - {L}_{f} {k}_{f} & - {k}_{f} & - {k}_{r} \\ {L}_{r} {k}_{r} - {L}_{f} {k}_{f} & {L}_{f}^{2} {k}_{f} + {L}_{r}^{2} {k}_{r} & {L}_{f} {k}_{f} & - {L}_{r} {k}_{r} \\ - {k}_{f} & {L}_{f} {k}_{f} & {k}_{f} + {k}_{tf} & 0 \\ - {k}_{r} & - {L}_{r} {k}_{r} & 0 & {k}_{r} + {k}_{tr}\end{matrix} ] & [ Math . 5 ]\end{matrix}$$

Furthermore, the right side of formula (1) is given by a vector P that is dependent on the variables expressing the unevenness of the road surface. The vector P is given by formula (6) below:

P=[00h_{f}k_{tf}hᵣkₜᵣ]^{T} [Math. 6]

In the following description, as indicated by formula (7), the 12 state variables are expressed by a vector x^{a}.

x^{a}=[u_{b}θu_{f}uᵣ\dot{u}_{b}\dot{θ}\dot{u}_{f}\dot{u}ᵣh_{f}hᵣ\dot{h}_{f}\dot{h}ᵣ]^{T} [Math. 7]

The prediction unit 13 expresses an error that may occur when the behavior of the vehicle 30 is modeled using a half car model in the form of a noise term. The prediction unit 13 determines the time evolution of the state variables x^{a} using the following formula (8).

x¹ₖ₊₁=Aₐx^{a}ₖ+ξₖ [Math. 8]

Here, subscript affixes “k” and “k+1” attached to the state variables x^{a} express time steps. A matrix Aₐ on the right side expresses the time evolution of the state variables, expressed by formula (1), as a linear transformation in time step units. When Aₐ is expressed as Aₐ=exp(AΔt), A is expressed by formula (9) below. Note that Δt expresses a unit time step.

$$A = [ \begin{matrix}{O}_{4 \times 4} & {I}_{4 \times 4} & {O}_{4 \times 2} \\ - {M}^{- 1} K & - {M}^{- 1} C & {Z}_{4 \times 4} \\ {O}_{2 \times 2} & {O}_{2 \times 2} & {T}_{4 \times 4}\end{matrix} ] \qquad [ Math . 9 ]$$

Here, the matrices M, C, and K are those shown in formulae (3) to (5). I_{4×4} is a 4×4 unit matrix, and the matrices O_{4×4}, O_{4×2}, and O_{2×2} are 4×4, 4×2, and 2×2 zero matrices, respectively. Further, a matrix Z is a quantity expressed by formula (10) below, while a matrix T is a quantity expressed by formula (11) below.

$$\begin{matrix}Z = [ \begin{matrix}0 & 0 & 0 & 0 \\ 0 & 0 & 0 & 0 \\ {k}_{tf} / {m}_{f} & 0 & 0 & 0 \\ 0 & 0 & {k}_{tr} / {m}_{r} & 0\end{matrix} ] & [ Math . 10 ] \\ T = [ \begin{matrix}0 & 1 & 0 & 0 \\ 0 & 0 & 0 & 0 \\ 0 & 0 & 0 & 1 \\ 0 & 0 & 0 & 0\end{matrix} ] & [ Math . 11 ]\end{matrix}$$

Further, ζₖ on the right side of formula (8) is the noise term in the time step k. The noise term ζₖ, as expressed by formula (12) below, includes an eight-dimensional vector wₖ and a four-dimensional vector ηₖ.

$${ζ}_{k} = [ \begin{matrix}{w}_{k} \\ {η}_{k}\end{matrix} ] \qquad [ Math . 12 ]$$

In the noise term ζₖ, the noise term wₖ with respect to the vertical displacement u_{b} and vertical speed du_{b}/dt of the center of gravity of the half car model, the vertical displacement u_{f} and vertical speed du_{f}/dt of the front suspension of the half car model, the vertical displacement uᵣ and vertical speed duᵣ/dt of the rear suspension of the half car model, and the angle of rotation θ and the angular velocity dθ/dt about the pitch axis passing through the center of gravity of the half car model is Gaussian noise with a mean of 0 and a variance-covariance matrix of Q. Note that δ_{k, l} represents the Kronecker delta.

E[wₖwₗ^{T}]=Qδ_{k,l} [Math. 13]

Furthermore, in the noise term ζₖ, the noise term ηₖ with respect to the vertical displacement h_{f} and vertical speed dh_{f}/dt of the front tire of the half car model, and the vertical displacement hᵣ and vertical speed dhᵣ/dt of the rear tire of the half car model is Gaussian noise with a mean of 0 and a variance-covariance matrix of S.

E[ηₖηₗ^{T}]=Sδ_{k,l} [Math. 14]

As is evident from formula (8), which expresses the time evolution of the state variables, the time evolution of the four-dimensional vector u gathering together the vertical displacement h_{f} and vertical speed dh_{f}/dt of the front tire of the half car model and the vertical displacement hᵣ and vertical speed dhᵣ/dt of the rear tire of the half car model is given by formula (15) below.

uₖ₊₁=uₖ+ηₖ [Math. 15]

The second calculation unit 14 calculates the acceleration, the angular velocity, the displacement, and the angular displacement from the state variables predicted by the prediction unit 13 on the basis of the observation model M2 (S13). The second calculation unit 14 calculates a vector y gathering together the acceleration, the angular velocity, the displacement, and the angular displacement from the state variables x^{a} predicted by the prediction unit 13 on the basis of the observation model M2, which is expressed by formula (16) below. The second calculation unit 14 models observation using a linear transformation Cₐ of the state variables and models an observation error using a noise term vₖ.

yₖ=Cₐxₖ^{a}+vₖ [Math. 16]

Here, the linear transformation Cₐ is given by formula (17) below. Here, O₄ is a 4×4 zero matrix.

$${C}_{a} = {[ \begin{matrix}{C}_{1} \\ {O}_{4}\end{matrix} ]}^{T} \qquad [ Math . 17 ]$$

The matrix C1 is given by formula (18) below.

$${C}_{1} = [ \begin{matrix}- \frac{{k}_{f} + {k}_{r}}{{m}_{H}} + \frac{( {L}_{f} - d ) ( {L}_{r} {k}_{r} - {L}_{f} {k}_{f} )}{{I}_{Z}} & 0 & 1 & 0 \\ - \frac{{L}_{r} {k}_{r} - {L}_{f} {k}_{f}}{{m}_{H}} + \frac{( {L}_{f } - d ) ( {L}_{f}^{2} {k}_{f} + {L}_{r}^{2} {k}_{r} )}{{I}_{Z}} & 0 & 0 & 1 \\ \frac{{k}_{f}}{{m}_{H}} + \frac{( {L}_{f} - d ) {L}_{f} {k}_{f}}{I} & 0 & 0 & 0 \\ \frac{{k}_{r}}{{m}_{H}} - \frac{( {L}_{f} - d ) {L}_{r} {k}_{r}}{{I}_{Z}} & 0 & 0 & 0 \\ - \frac{{c}_{f} + {c}_{r}}{{m}_{H}} + \frac{( {L}_{f} - d ) ( {L}_{r} {c}_{r} - {L}_{f} {c}_{f} )}{{I}_{Z}} & 0 & 0 & 0 \\ - \frac{{L}_{r} {c}_{r} - {L}_{f} {c}_{f}}{{m}_{H}} + \frac{( {L}_{f } - d ) ( {L}_{f}^{2} {c}_{f} - {L}_{r}^{2} {c}_{r} )}{{I}_{Z}} & 1 & 0 & 0 \\ \frac{{c}_{f}}{{m}_{H}} + \frac{( {L}_{f} - d ) {L}_{f} {c}_{f}}{{I}_{Z}} & 0 & 0 & 0 \\ \frac{{c}_{r}}{{m}_{H}} - \frac{( {L}_{f} - d ) {L}_{r} {c}_{r}}{{I}_{Z}} & 0 & 0 & 0\end{matrix} ] \qquad [ Math . 18 ]$$

Further, the noise term Vₖ on the right side of formula (14) is Gaussian noise with a mean of 0 and a variance-covariance matrix of R.

E[vₖvₗ^{T}]=Rδ_{k,l} [Math. 19]

The updating unit 15 updates the state variables using an optimal Kalman gain (S14). Here, the optimal Kalman gain is an updating coefficient determined so as to minimize the square error of the state variables, and is given by formula (20) below.

Gₖ₊₁=Pₖ₊₁⁻Cₐ^{T}[CₐPₖ₊₁⁻Cₐ^{T}+Rₖ₊₁]⁻¹ [Math. 20]

Pₖ₊₁⁻ on the right side of formula (20) is the variance of the pre-update state variables in the time step k+1. An initial value of an expected value of the state variables is given by formula (21) below, and an initial value of the variance is given by formula (22) below. Note that the state variables x^{a} with a hat symbol attached thereto express estimated values.

\hat{x}₀^{a}=E[x₀] [Math. 21]

P₀=E[(x₀−E[x₀])(x₀−E[x₀])^{T}] [Math. 22]

As described above, the time evolution of the expected value of the state variables x^{a} is given by formula (23) below.

\hat{x}ₖ₊₁^{a-}=Aₐ\hat{x}ₖ^{a} [Math. 23]

Here, the superscript symbol “-” indicates a pre-update quantity. Further, the time evolution of the variance of the state variables x^{a} is given by formula (24) below.

Pₖ₊₁⁻=AₐPₖAₐ^{T}+Qₖ [Math. 24]

The updating unit 15 determines the expected value of the updated state variables x^{a} using formula (25) below.

\hat{x}ₖ₊₁^{a}=\hat{x}ₖ₊₁^{a-}+Gₖ₊₁(yₖ₊₁−Cₐ\hat{x}ₖ₊₁^{a-}) [Math. 25]

Here, “yₖ₊₁” on the right side expresses the acceleration and angular velocity acquired by the acquisition unit 11 and the displacement and angular displacement calculated by the first calculation unit 12 in the time step k+1, and is an actual measured value acquired in relation to the vehicle 30. The second term on the right side is a term for correcting the state variables using a value obtained by multiplying an optimal Kalman gain Gₖ₊₁ by a difference between the measured values yₖ₊₁ and observed values calculated from the state values xₖ₊₁^{a-}.

The updating unit 15 determines the variance of the updated state variables x^{a} using formula (26) below.

Pₖ₊₁=(I−Gₖ₊₁Cₐ)Pₖ₊₁⁻ [Math. 26]

By predicting the state variables and updating the state variables in accordance with the difference with the measured values in every time step, as described above, the state variables can be estimated with a high degree of precision. By expressing the time evolution of the state variables using the simulation model M1 including a linear transformation and Gaussian noise, and expressing observation using the observation model M2 including a linear transformation and Gaussian noise, the road surface profile can be estimated by comparatively low-load calculation.

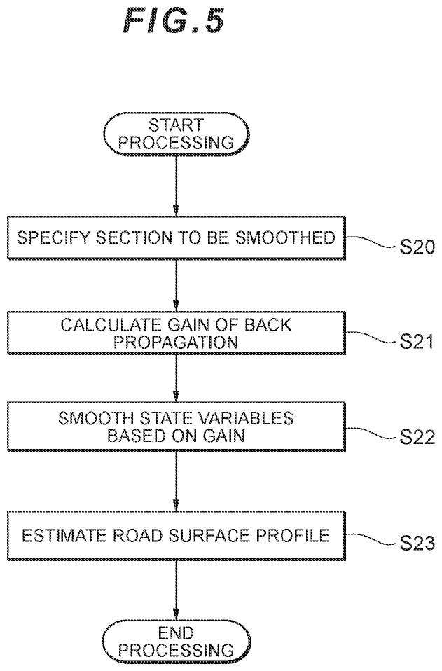

FIG. 5 is a flowchart of second processing executed by the road surface profile estimation device 10 according to the first embodiment of the present invention. The second processing is processing executed by the road surface profile estimation device 10 to estimate the road surface profile by implementing smoothing processing on the state variables.

First, the smoothing unit 16 receives specification of a section in which smoothing is to be implemented (S20). When time steps from k=0 to k=T exist, in order to smooth the state variables xₖ of a time step k, the smoothing unit 16 may use all subsequent state variables xₖ₊₁, Xₖ₊₂, . . . , x_{T}. Alternatively, a section L (where L is an arbitrary natural number) may be specified, and the state variables may be smoothed using xₖ₊₁, xₖ₊₂, . . . , x_{k+L}.

The smoothing unit 16 initializes an expected value of the smoothed state variables using formula (27) below, and initializes a variance of the smoothed state variables using formula (28) below.

\hat{x}_{N}=\hat{x}_{N}^{a} [Math. 27]

P_{N}^{b}=P_{N} [Math. 28]

Next, the smoothing unit 16 calculates a gain Φ of back propagation during the smoothing processing using formula (29) below (S21).

Φₖ=PₖAₐ[Pₖ₊₁⁻]⁻¹ [Math. 29]

Then, on the basis of the gain Φ, the smoothing unit 16 smoothes the expected value of the state variables back into the past from the time step k=T using formula (30) below. Further, the smoothing unit 16 smoothes the variance of the state variables using formula (31) below (S22).

\hat{x}ₖ=\hat{x}ₖ^{a}+Φₖ(\hat{x}ₖ₊₁−\hat{x}ₖ₊₁^{a-1}) [Math. 30]

Pₖ^{b}=Pₖ−Φₖ(Pₖ₊₁⁻−Pₖ₊₁^{b})Φ [Math. 31]

Thus, the state variables are smoothed. Next, the estimation unit 17 estimates the profile of the road surface on the basis of the variables expressing the unevenness of the road surface, included in the state variables (S23). More specifically, the estimation unit 17 estimates the profile of the road surface on the basis of the vertical displacement h_{f} of the front tire of the half car model and the vertical displacement hᵣ of the rear tire of the half car model.

With the road surface profile estimation device 10 according to this embodiment, by employing in data assimilation not only the vertical acceleration relative to the road surface with which the vehicle 30 is in contact and the angular velocity about the pitch axis of the vehicle 30 but also the vertical displacement and the angular displacement about the pitch axis, highly stable analysis can be realized, and as a result, the profile of any road surface, including that of a general road, can be estimated with a high degree of precision using a general-purpose vehicle. Moreover, by employing in data smoothing not only the vertical acceleration and the angular velocity about the pitch axis but also the vertical displacement and the angular displacement about the pitch axis, the road surface profile can be estimated with an even higher degree of precision.

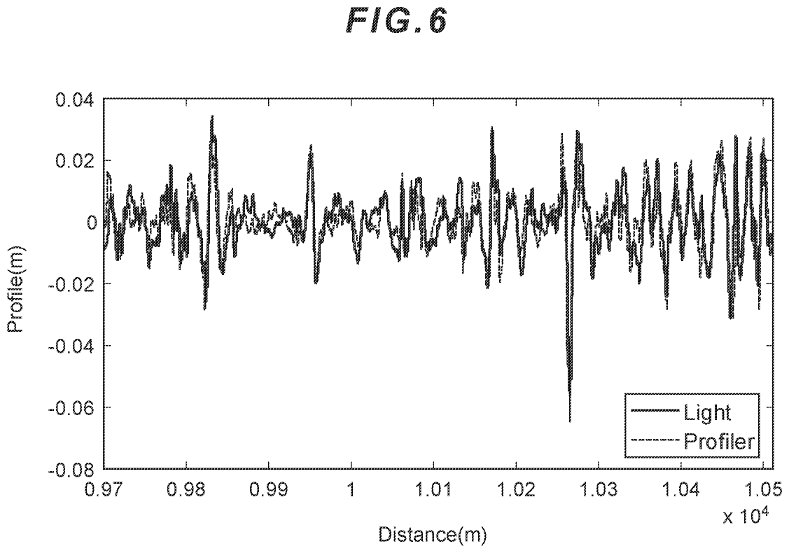

FIG. 6 is a first graph showing a relationship between a travel distance and the road surface profile, estimated by the road surface profile estimation system 1 according to the first embodiment of the present invention. In the figure, the travel distance (Distance) is shown on the horizontal axis in units of meters (m), and the road surface profile is shown on the vertical axis in units of meters (m). On the first graph, a road surface profile estimated by the road surface profile estimation system 1 according to this embodiment using a light vehicle (Light) is indicated by a solid line, and a road surface profile estimated using a dedicated vehicle (Profiler) is indicated by a dotted line. It is evident from the first graph that the road surface profile estimated by the road surface profile estimation system 1 according to this embodiment using a light vehicle and the road surface profile estimated using a dedicated vehicle substantially match. Hence, with the road surface profile estimation system 1 according to this embodiment, a road surface profile can be estimated with an approximately identical degree of precision to that achieved by a dedicated vehicle using a light vehicle and the smartphone 20.

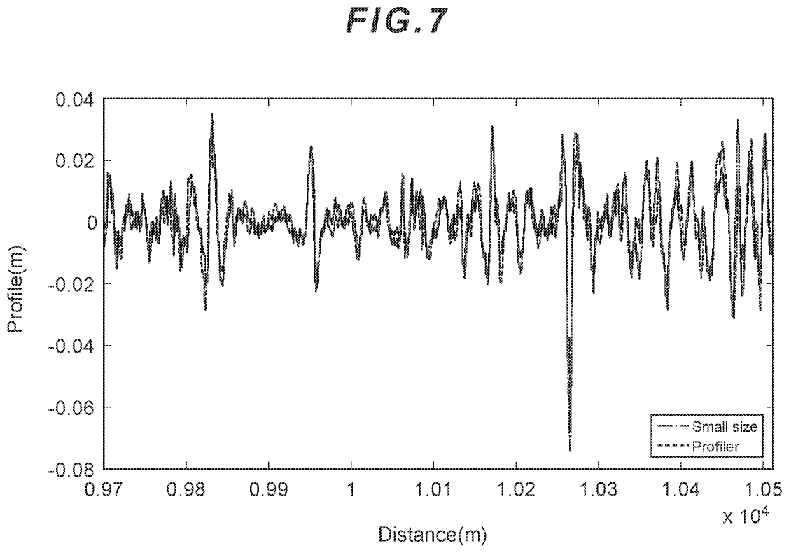

FIG. 7 is a second graph showing the relationship between the travel distance and the road surface profile, estimated by the road surface profile estimation system 1 according to the first embodiment of the present invention. In the figure, the travel distance (Distance) is shown on the horizontal axis in units of meters (m), and the road surface profile is shown on the vertical axis in units of meters (m). On the second graph, a road surface profile estimated by the road surface profile estimation system 1 according to this embodiment using a small vehicle (Small size) is indicated by a dot-dash line, and a road surface profile estimated using a dedicated vehicle (Profiler) is indicated by a dotted line. It is evident from the second graph that the road surface profile estimated by the road surface profile estimation system 1 according to this embodiment using a small vehicle and the road surface profile estimated using a dedicated vehicle substantially match. Hence, with the road surface profile estimation system 1 according to this embodiment, a road surface profile can be estimated with an approximately identical degree of precision to that achieved by a dedicated vehicle using a small vehicle and the smartphone 20.

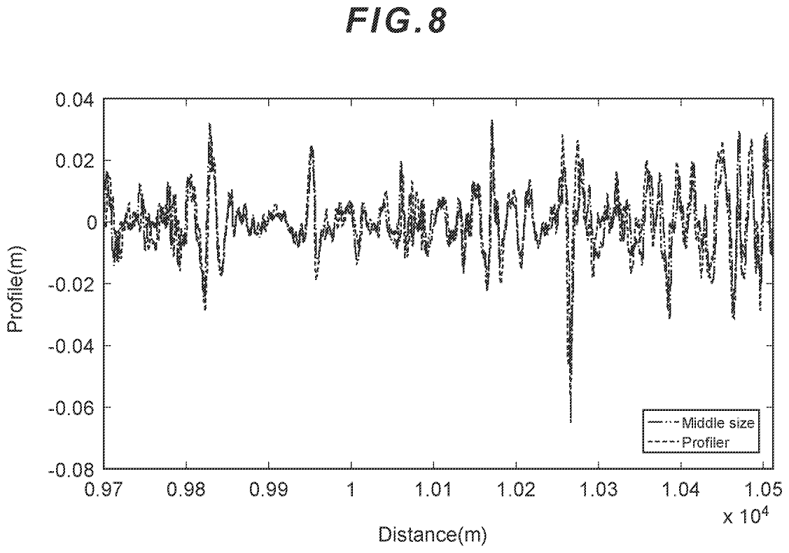

FIG. 8 is a third graph showing the relationship between the travel distance and the road surface profile, estimated by the road surface profile estimation system 1 according to the first embodiment of the present invention. In the figure, the travel distance (Distance) is shown on the horizontal axis in units of meters (m), and the road surface profile is shown on the vertical axis in units of meters (m). On the third graph, a road surface profile estimated by the road surface profile estimation system 1 according to this embodiment using a middle-sized vehicle (Middle size) is indicated by a dot-dot-dash line, and a road surface profile estimated using a dedicated vehicle (Profiler) is indicated by a dotted line. It is evident from the third graph that the road surface profile estimated by the road surface profile estimation system 1 according to this embodiment using a middle-sized vehicle and the road surface profile estimated using a dedicated vehicle substantially match. Hence, with the road surface profile estimation system 1 according to this embodiment, a road surface profile can be estimated with an approximately identical degree of precision to that achieved by a dedicated vehicle using a middle-sized vehicle and the smartphone 20.

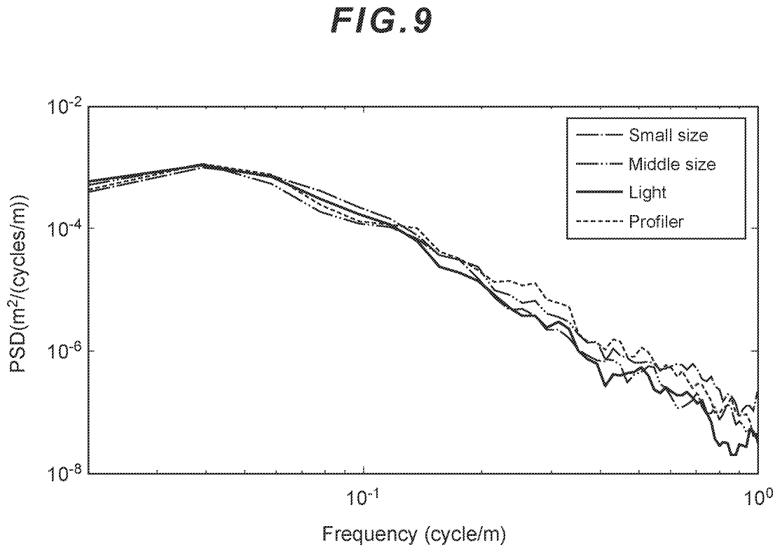

FIG. 9 is a fourth graph showing a power spectrum of the road surface profile estimated by the road surface profile estimation system 1 according to the first embodiment of the present invention. In the figure, a frequency (Frequency) is shown on the horizontal axis in units of cycles/meter (cycle/m), and a power spectrum density (PSD) of the road surface profile is shown on the vertical axis in units of m²/(cycle/m). On the fourth graph, the power spectrum density of the road surface profile estimated by the road surface profile estimation system 1 according to this embodiment using a light vehicle (Light) is indicated by a solid line, the power spectrum density of the road surface profile estimated by the road surface profile estimation system 1 according to this embodiment using a small vehicle (Small size) is indicated by a dot-dash line, the power spectrum density of the road surface profile estimated by the road surface profile estimation system 1 according to this embodiment using a middle-sized vehicle (Middle size) is indicated by a dot-dot-dash line, and the power spectrum density of the road surface profile estimated using a dedicated vehicle (Profiler) is indicated by a dotted line. It is evident from the fourth graph that when any of a light vehicle, a small vehicle, and a middle-sized vehicle is used, the power spectrum density of the road surface profile estimated by the road surface profile estimation system 1 according to this embodiment substantially matches the power spectrum density of the road surface profile estimated using a dedicated vehicle. Hence, with the road surface profile estimation system 1 according to this embodiment, a road surface profile can be estimated with an approximately identical degree of precision to that achieved by a dedicated vehicle using any desired vehicle and the smartphone 20.

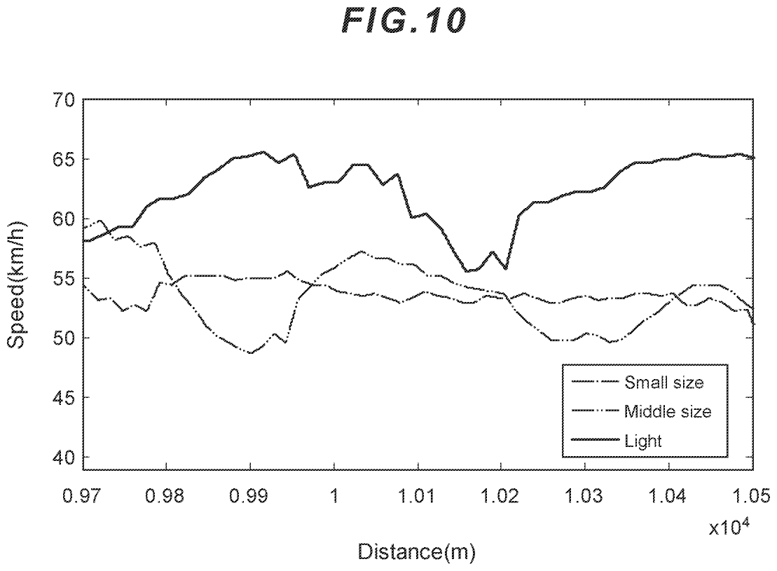

FIG. 10 is a fifth graph showing the travel distance and the speed of the vehicle 30 during estimation of the road surface profile by the road surface profile estimation system 1 according to the first embodiment of the present invention. In the figure, the travel distance (Distance) is shown on the horizontal axis in units of meters (m), and the speed of the vehicle 30 is shown on the vertical axis in units of kilometers per hour (km/h). On the fifth graph, the speed of a light vehicle (Light) is indicated by a solid line, the speed of a small vehicle (Small size) is indicated by a dot-dash line, and the speed of a middle-sized vehicle (Middle size) is indicated by a dot-dot-dash line. It is evident from the fifth graph that the respective speeds of the light vehicle, the small vehicle, and the middle-sized vehicle are not constant, and that the respective speeds vary differently over time. Hence, with the road surface profile estimation system 1 according to this embodiment, even when the speed of the vehicle 30, which is used to measure the acceleration and angular velocity, varies, the road surface profile is estimated with stability. As a result, with the road surface profile estimation system 1 according to this embodiment, a road surface profile can be estimated with a high degree of precision regardless of the size and travel speed of the vehicle 30 in which the smartphone 20 having the built-in accelerometer 21 and angular velocity meter 22 is disposed. Note that even when the location of the smartphone 20 having the built-in accelerometer 21 and angular velocity meter 22 is modified, by modifying the horizontal distance d from the ground contact point of the front tire to the disposal point of the accelerometer 21 and the angular velocity meter 22, which is one of the parameters of the simulation model M1, the road surface profile can be estimated with a high degree of precision.

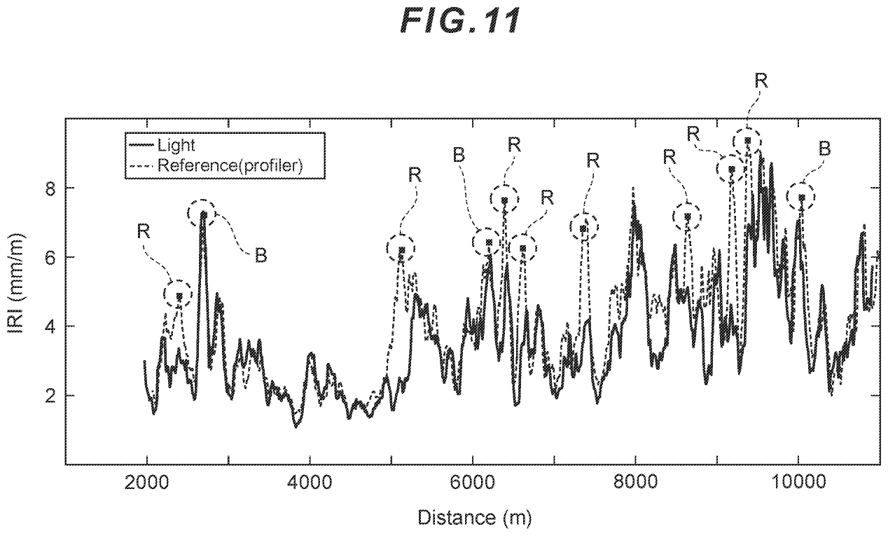

FIG. 11 is a sixth graph showing the travel distance and the speed of the vehicle 30 during estimation of the road surface profile by the road surface profile estimation system 1 according to the first embodiment of the present invention. In the figure, the travel distance (Distance) is shown on the horizontal axis in units of meters (m), and the IRI, which is an index of the road surface profile, is shown on the vertical axis in units of millimeters/meter (mm/m). On the sixth graph, an IRI estimated by the road surface profile estimation system 1 according to this embodiment using a light vehicle (Light) is indicated by a solid line, and an IRI estimated using a dedicated vehicle is indicated by a dotted line. Further, on the sixth graph, “R” denotes locations in which the dedicated vehicle stops for red lights, and “B” denotes locations in which the dedicated vehicle starts on green lights. It is evident from the sixth graph that in the locations where the dedicated vehicle starts on green lights, the IRI estimated by the road surface profile estimation system 1 according to this embodiment substantially matches the IRI estimated using the dedicated vehicle, but in the locations where the dedicated vehicle stops for red lights, the IRI estimated by the road surface profile estimation system 1 according to this embodiment diverges from the IRI estimated using the dedicated vehicle. Considering that the divergence between the IRI estimated by the road surface profile estimation system 1 according to this embodiment and the IRI estimated using the dedicated vehicle is concentrated in the locations where the dedicated vehicle stops and starts and that the dedicated vehicle is designed envisaging measurement during high-speed travel and may therefore be unable to estimate the IRI of the road surface precisely immediately before and after stopping and starting, the IRI estimated using the dedicated vehicle may deviate from the true value thereof immediately before and after stopping and starting. With the road surface profile estimation system 1 according to this embodiment, the IRI of the road surface can be estimated with a high degree of precision even when the vehicle 30 stops and starts. Hence, with the road surface profile estimation system 1 according to this embodiment, the profile of a road surface can be estimated with a high degree of precision even on a general road where frequent stops and starts are unavoidable.

### Second Embodiment

In the road surface profile estimation system 1 according to a second embodiment, the simulation model M1 and observation model M2 stored in the storage unit 18 of the road surface profile estimation device 10 differ from those of the first embodiment. With regard to all other configurations, the road surface profile estimation system 1 according to the second embodiment is configured similarly to the road surface profile estimation system according to the first embodiment. In the road surface profile estimation device 10 according to this embodiment, the simulation model M1 is a model expressing the time evolution of the state variables using either a linear transformation or a non-linear transformation of the state variables and either Gaussian noise or non-Gaussian noise, and the observation model M2 is a model used to calculate the vertical acceleration relative to the road surface with which the vehicle 30 is in contact, the angular velocity about the pitch axis of the vehicle 30, the vertical displacement, and the angular displacement about the pitch axis using either a linear transformation or a non-linear transformation of the state variables and either Gaussian noise or non-Gaussian noise. As will be described in detail below, the prediction unit 13, the second calculation unit 14, and the updating unit 15 of the road surface profile estimation device 10 according to this embodiment together function as a particle filter.

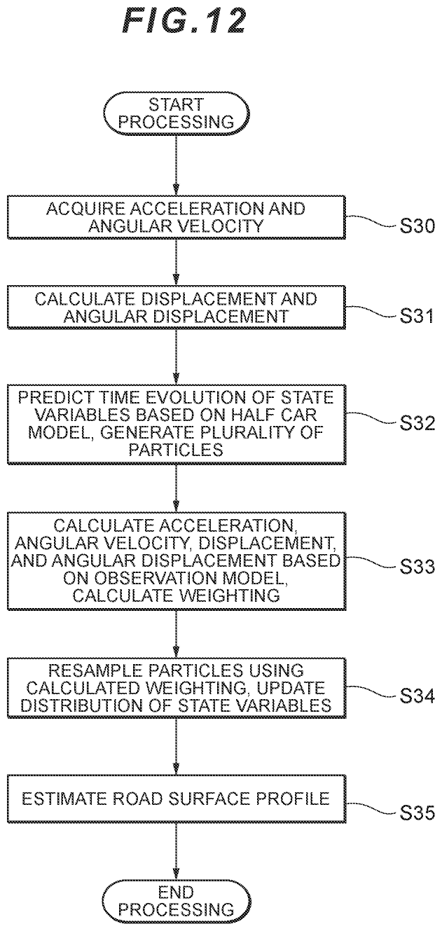

FIG. 12 is a flowchart of third processing executed by the road surface profile estimation device 10 according to the second embodiment of the present invention. The third processing is processing executed by the road surface profile estimation device 10 to data-assimilate the state variables and the measured values using a particle filter.

The road surface profile estimation device 10 uses the acquisition unit 11 to acquire the vertical acceleration relative to the road surface with which the vehicle 30 is in contact and the angular velocity about the pitch axis of the vehicle 30 (S30). Measurement of the acceleration by the accelerometer 21 and measurement of the angular velocity by the angular velocity meter 22 may be performed at predetermined time intervals. The acquisition unit 11 may acquire the acceleration and the angular velocity every time measurement is performed by the accelerometer 21 and the angular velocity meter 22 or acquire the acceleration and the angular velocity together once measurement is complete.

The first calculation unit 12 calculates the vertical displacement by integrating the acceleration acquired by the acquisition unit 11, and calculates the angular displacement about the pitch axis by integrating the angular velocity (S31). The acceleration and angular velocity acquired by the acquisition unit 11 and the displacement and angular displacement calculated by the first calculation unit 12 are expressed together by the vector y.

The prediction unit 13 predicts the time evolution of the state variables on the basis of the half car model and generates a plurality of particles on the basis of a probability distribution of the predicted state variables (S32). The time evolution of the state variables is determined using the simulation model M1, which is expressed by formula (32) below.

xₖ₊₁=fₖ(xₖ)+w(k) [Math. 32]

Here, fₖ is the linear transformation or non-linear transformation of the state variables xₖ in the time step k. Further, w(k) is the noise term of the time step k and denotes Gaussian noise or non-Gaussian noise with a mean of 0. The prediction unit 13 generates N particles xₖ₋₁(i) on the basis of a probability distribution p(xₖ₋₁|y_{1:k-1}), determines xₖ(i) by predicting the time evolution using formula (32), and determines a predicted probability distribution p(xₖ|y_{1:k-1}) of the state variables in the time step k approximately using formula (33) below.

$$p ( {x}_{k} \vert {y}_{1 : k - 1} ) = {\sum }_{i = 1}^{N} p ( {x}_{k - 1} \vert {y}_{1 : k - 1} ) δ ( {x}_{k} - {x}_{k} ( i ) ) \qquad [ Math . 33 ]$$

Here, y_{1:k-1} represents the acceleration, angular velocity, displacement, and angular displacement measured from the time step k=1 to the time step k−1. Further, δ represents a delta function. Furthermore, i=1, 2, . . . N. Note that an initial condition p(x₁|y_{1:1}) may be assumed to be a uniform distribution, for example, or may be set as p(x₂|y_{1:1})=Σᵢ₌₁^{N}δ (x₂−x₂ (i))/N. Needless to mention, the initial condition does not have to be a uniform distribution, and any desired distribution may be assumed.

The second calculation unit 14 calculates the acceleration, the angular velocity, the displacement, and the angular displacement from the state variables predicted by the prediction unit 13 on the basis of the observation model M2, and calculates a weighting to be used during updating (S33). The second calculation unit 14 calculates the acceleration, angular velocity, displacement, and angular displacement yₖ from the state variables xₖ predicted by the prediction unit 13 on the basis of the observation model M2, which is expressed by formula (33) below.

yₖ=hₖ(xₖ)+v(k) [Math. 34]

Here, hₖ is the linear transformation or non-linear transformation of the state variables xₖ in the time step k. Further, v(k) is the noise term of the time step k and denotes Gaussian noise or non-Gaussian noise with a mean of 0. The second calculation unit 14 determines the probability distribution p(yₖ|xₖ (i)) of the measured values in a case where the particles xₖ(i) are acquired in the time step k on the basis of the observation model M2 expressed by formula (33), and calculates a weighting qᵢ using formula (34) below.

$${q}_{i} = p ( {y}_{k} \vert {x}_{k} ( i ) ) / {\sum }_{i = 1}^{N} p ( {y}_{k} \vert {x}_{k} ( i ) ) \qquad [ Math . 35 ]$$

The updating unit 15 resamples the particles using the calculated weighting qᵢ, and updates the probability distribution of the state variables (S34). The updating unit 15 determines a probability distribution p(xₖ|y_{1:k}) of the state variables in the time step k following acquisition of the measured values yₖ approximately using p(xₖ|y_{1:k})=Σₖ₌₁^{N}qᵢδ (xₖ−xₖ (i))/N.

The estimation unit 17 estimates the road surface profile on the basis of the probability distribution p(xₖ|y_{1:k}) of the state variables (S35). The estimation unit 17 may estimate the road surface profile by determining the expected value of the variables representing the unevenness of the road surface, included in the state variables.

With the road surface profile estimation device 10 according to this embodiment, the time evolution of the state variables can be expressed using the simulation model M1 including a non-linear transformation and non-Gaussian noise, and observation can be expressed using the observation model M2 including a non-linear transformation and non-Gaussian noise. Thus, non-linear behavior and non-Gaussian vibration can be described accurately, and as a result, the road surface profile can be estimated with an even higher degree of precision.

The embodiments described above are provided to facilitate understanding of the present invention and are not to be interpreted as limiting the present invention. The respective elements included in the embodiments, as well as the arrangements, materials, conditions, shapes, sizes, and so on thereof, are not limited to those cited in the embodiments and may be modified as appropriate. Moreover, configurations cited in other embodiments may be partially replaced or combined.

1. A road surface profile estimation device comprising:
an acquisition unit that acquires a vertical acceleration relative to a road surface with which a vehicle is in contact and angular velocity about a pitch axis of the vehicle;
a first calculation unit that calculates a vertical displacement by integrating the acceleration and calculates an angular displacement about the pitch axis by integrating the angular velocity;
a prediction unit that predicts, on the basis of a simulation model, a time evolution of state variables including variables expressing unevenness on a road surface along which the vehicle is traveling, variables expressing up-down motion of the vehicle, and variables expressing rotary motion about the pitch axis of the vehicle;
a second calculation unit that calculates, on the basis of an observation model, the acceleration, the angular velocity, the displacement, and the angular displacement from the state variables predicted by the prediction unit;
an updating unit that updates the state variables by data-assimilating the acceleration and the angular velocity acquired by the acquisition unit and the displacement and the angular displacement calculated by the first calculation unit with the acceleration, the angular velocity, the displacement, and the angular displacement calculated by the second calculation unit; and
an estimation unit that estimates the road surface profile on the basis of the variables expressing the unevenness of the road surface, included in the state variables.

2. The road surface profile estimation device according to claim 1, further comprising a smoothing unit that smoothes the state variables on the basis of the acceleration and the angular velocity acquired by the acquisition unit and the displacement and the angular displacement calculated by the first calculation unit following a point at which the prediction unit executes prediction.

3. The road surface profile estimation device according to claim 1, wherein the simulation model is a half car model of the vehicle, and
the state variables are variables expressing states of the half car model.

4. The road surface profile estimation device according to claim 3, wherein the variables expressing the unevenness of the road surface include a vertical displacement and a vertical speed of a front tire of the half car model, and a vertical displacement and a vertical speed of a rear tire of the half car model,
the variables expressing the up-down motion of the vehicle include a vertical displacement and a vertical speed of a center of gravity of the half car model, a vertical displacement and a vertical speed of a front suspension of the half car model, and a vertical displacement and a vertical speed of a rear suspension of the half car model, and
the variables expressing the rotary motion about the pitch axis of the vehicle include an angle of rotation and an angular velocity about a pitch axis passing through the center of gravity of the half car model.

5. The road surface profile estimation device according to any one of claim 1 wherein the simulation model is a model expressing the time evolution of the state variables by a linear transformation or a non-linear transformation of the state variables and Gaussian noise or non-Gaussian noise, and
the observation model is a model for calculating the acceleration, the angular velocity, the displacement, and the angular displacement using a linear transformation or a non-linear transformation of the state variables and Gaussian noise or non-Gaussian noise.

6. The road surface profile estimation device according to claim 5, wherein the simulation model is a model expressing the time evolution of the state variables by a linear transformation of the state variables and Gaussian noise,
the observation model is a model for calculating the acceleration, the angular velocity, the displacement, and the angular displacement using a linear transformation of the state variables and Gaussian noise, and
the updating unit updates the state variables so as to minimize a square error of the state variables.

7. A road surface profile estimation system comprising:
an accelerometer disposed in a vehicle in order to measure a vertical acceleration relative to a road surface with which the vehicle is in contact;
an angular velocity meter disposed in the vehicle in order to measure an angular velocity about a pitch axis of the vehicle; and
a road surface profile estimation device for estimating a profile of a road surface along which the vehicle is traveling,
the road surface profile estimation device comprising:
an acquisition unit that acquires the acceleration from the accelerometer and the angular velocity from the angular velocity meter;
a first calculation unit that calculates a vertical displacement by integrating the acceleration and calculates an angular displacement about the pitch axis by integrating the angular velocity;
a prediction unit that predicts, on the basis of a simulation model, a time evolution of state variables including variables expressing unevenness on the road surface along which the vehicle is traveling, variables expressing up-down motion of the vehicle, and variables expressing rotary motion about the pitch axis of the vehicle;
a second calculation unit that calculates, on the basis of an observation model, the acceleration, the angular velocity, the displacement, and the angular displacement from the state variables predicted by the prediction unit;
an updating unit that updates the state variables by data-assimilating the acceleration and the angular velocity acquired by the acquisition unit and the displacement and the angular displacement calculated by the first calculation unit with the acceleration, the angular velocity, the displacement, and the angular displacement calculated by the second calculation unit; and
an estimation unit that estimates the road surface profile on the basis of the variables expressing the unevenness of the road surface, included in the state variables.

8. A method of estimating a road surface profile which comprises:
a first step of acquiring a vertical acceleration relative to a road surface with which a vehicle is in contact and angular velocity about a pitch axis of the vehicle;
a second step of calculating a vertical displacement by integrating the acceleration and calculating an angular displacement about the pitch axis by integrating the angular velocity;
a third step of predicting, on the basis of a simulation model, a time evolution of state variables including variables expressing unevenness on a road surface along which the vehicle is traveling, variables expressing up-down motion of the vehicle, and variables expressing rotary motion about the pitch axis of the vehicle;
a fourth step of calculating, on the basis of an observation model, the acceleration, the angular velocity, the displacement, and the angular displacement from the state variables predicted in the third step;
a fifth step of updating the state variables by data-assimilating the acceleration and the angular velocity acquired in the first step and the displacement and the angular displacement calculated in the second step with the acceleration, the angular velocity, the displacement, and the angular displacement calculated in the fourth step; and
a sixth step of estimating the road surface profile on the basis of the variables expressing the unevenness of the road surface, included in the state variables.

9. A non-transitory recording medium recording computer readable program, when executed by a computer provided in a road surface profile estimation device, cause the computer to function as:
an acquisition unit that acquires a vertical acceleration relative to a road surface with which a vehicle is in contact and angular velocity about a pitch axis of the vehicle;
a first calculation unit that calculates a vertical displacement by integrating the acceleration and calculates an angular displacement about the pitch axis by integrating the angular velocity;
a prediction unit that predicts, on the basis of a simulation model, a time evolution of state variables including variables expressing unevenness on a road surface along which the vehicle is traveling, variables expressing up-down motion of the vehicle, and variables expressing rotary motion about the pitch axis of the vehicle;
a second calculation unit that calculates, on the basis of an observation model, the acceleration, the angular velocity, the displacement, and the angular displacement from the state variables predicted by the prediction unit;
an updating unit that updates the state variables by data-assimilating the acceleration and the angular velocity acquired by the acquisition unit and the displacement and the angular displacement calculated by the first calculation unit with the acceleration, the angular velocity, the displacement, and the angular displacement calculated by the second calculation unit; and
an estimation unit that estimates the road surface profile on the basis of the variables expressing the unevenness of the road surface, included in the state variables.
